(19) United States
(12) Patent Application Publication
(10) Pub. No.: US 2001/0045327 A1
(43) Pub. Date: Nov. 29, 2001

(54) Elevator door control device

(76) Inventors: Kenneth J. Shemanske, II, West Dundee, IL (US); Dominic P. Ankers, Pleasant Ridge, MI (US)

Correspondence Address: Mathew R. P. Perrone, Jr., 210 South Main Street, Algonquin, IL, 60102-2639, US

(21) Appl. No.: 09/825,044

(22) Filed: Apr. 4, 2001

Related U.S. Application Data
(60) Provisional application No. 60/169,709, filed on Dec. 8, 1999.

(51) Int. Cl. B66B 13/26

(52) U.S. Cl. 187/317

(57) ABSTRACT

The elevator door control device and method control operation of an elevator cab door by monitoring obstruction in an area adjacent the door and causing operation of the door as necessitated by the obstruction sensed. Secondarily, the elevator door control device and method enhance security by creating saved images of the area monitored for review if desired. Further, the elevator door control device and method include a learn feature whereby parameters of the particular installation are incorporated over time into programming to update same.

### CROSS REFERENCE TO RELATED APPLICATION

This application is based on U.S. Provisional Application Number 60/169,709, filed Dec. 8, 1999, of the same title and the same inventorship, and priority thereof is hereby claimed, said application being incorporated herein by reference.

This invention relates to an elevator control device, and more particularly to an elevator door control device operated by parameters resulting from the use of a series of rapidly analyzed pictures.

### BACKGROUND OF THE INVENTION

Elevators are in common use in multistory buildings. This is especially true in commercial buildings. With the addition of each elevator to a building, an additional electromechanical device is use. As with any mechanical device, problems can develop.

A typical elevator has two doors. The elevator includes a cab which has a door closing the cab. At each floor of a multistory building, where the cab of the elevator stops the door, the inner elevator cab door opens, and the outer door at the floor opens too. The door at the floor provides the second elevator door. Both doors must cooperate for the elevator to function.

In order to accomplish the function of both doors, there is a cab sill at the bottom of the elevator for the cab door and an entrance sill in the hall or other area for the outer door, to which the elevator provides access. The controlling of the opening of these doors is a problem. It is desired to provide exclusive and accurate control of the doors so that any obstruction appearing in the doorway can result in the closing procedure for both of the elevator doors to be halted or reversed very quickly.

### PRIOR ART DISCUSSION

Heretofore numerous electronically controlled and operated elevator doors and methods for controlling the same have been proposed. Examples of prior art systems and methods for elevator door control and operation can be found in U.S. Pat. Nos. 5,042,620; 5,387,768; and 5,518,086. Other prior art systems and methods, which may be of some lesser significance in the teachings of the instant application may be found in U.S. Pat. Nos. 4,044,860; 4,524,384; 4,924,416; 5,258,586; 5,298,697; and 6,050,369.

One such problem, as referred to above, is a false claim of injury. It is desired to minimize such law suits. Typical of the law suits are those, wherein it is claimed that the door has struck a person. It is desired to minimize the problem of these law suits and provide additional protection, by avoiding an improper closing of the door, which can result in a person being contacted or injured. However, the many devices available for this purpose lack the durability and efficiency required. Thus, many injuries can occur, each of which, in turn, can result in a serious personal injury law suit.

It is desired to provide a closing mechanism that can be used to control the elevator door. Each floor, at which the elevator stops, creates a different door operation procedure. However, of the closing mechanisms available, it is possible usually to set the elevator door in only one manner for only one floor, no matter how many floors it covers.

Yet each floor, at which the elevator may or does stop, creates a different set of circumstances, which can adversely affect the elevator. It is desired to permit the door closing mechanism to adjust to these different circumstances. However, no adequate device or method for accomplishing this feature is known.

Currently, such a closing device uses a cable or electric eye on a door, which cable runs along the door frame. This electric eye provides structure for keeping the door open or closed. Unfortunately, this structure requires a number of cables to run along the door. Such cables can be damaged and prevent the door from operating properly. Such a cable structure has a high maintenance cost and is difficult to use effectively.

### SUMMARY OF THE INVENTION

According to the invention there is provided a system for controlling operation of an elevator door, the system comprising:

an imaging apparatus mounted relative to an elevator door in a position for imaging areas adjacent the door;

a preprogrammed module functionally engaged to the imaging apparatus, and receiving and analyzing continuously input therefrom, the module also being functionally engaged to operating structures of the door for eliciting opening and closing of the door based on determination of differences between sequential images.

The system is a smart system capable of updating internal parameters, over time, of the particular installation and stores images for future retrieval, if review of the images is desired.

Still further according to the invention there is provided a method for controlling operation of an elevator door comprising the steps of:

providing an imaging apparatus in a position to allow continuous sequential imaging of an area adjacent the elevator door;

providing a preprogrammed image analyzer to the imaging apparatus for analyzing differences between sequential images received from the imaging device;

providing a preprogrammed processor functionally engaged to the image analyzer for determining an appropriate door obstruction required by any analyzed differences;

functionally engaging the preprogrammed processor to operating structures of the door;

and, based upon analyzed differences eliciting appropriate obstruction of the elevator door in response to such analyzed differences.

These and other objectives of the invention (which other objectives become clear by consideration of the specification, claims and drawings as a whole) are met by providing an elevator door control device having a camera adapted to take a series of pictures of the elevator door opening, an analyzing device for comparing the series of pictures, and an operating mechanism for the door, to open or close the door, at a point when the picture analysis indicates such action is permissible or desired.

### BRIEF DESCRIPTION OF THE DRAWINGS

FIG. 1 depicts a front perspective view of the elevator door control device 100 of the present invention in use on an elevator 102.

FIG. 2 depicts a side, partially cross-sectioned, perspective view of the elevator door control device 100 of the present invention in use on an elevator 102.

FIG. 3 depicts a simplified schematic block diagram of the elevator door control device 100 of the present invention.

FIG. 4 depicts a detailed block diagram representation of a preferred embodiment of the elevator door control device 100 of the present invention.

FIG. 4 presents a first logic flow diagram 150 of processor programming for the elevator door control device 100 of the present invention.

FIG. 5 presents a second logic flow diagram 160 of processor programming for the elevator door control device 100 of the present invention.

Throughout the figures of the drawings, where the same part appears in more than one figure of the drawings, the same number is applied thereto.

### DESCRIPTION OF THE PREFERRED EMBODIMENTS

The present invention relates to an apparatus and method, which monitor and control elevator door function, are capable of learning, and provide enhanced security secondarily. More particularly, the elevator door control device incorporates an imaging apparatus and a preprogrammed processor, with a learning module, for controlling door function while at the same time producing an image stream which can be viewed, should such security measure be required.

A closing mechanism, which will allow the elevator door to open and close, based on a set of rules contained within the device. These rules are constantly updated as the device operates. The closing and opening device for the elevator door is thus able to adjust to different circumstances.

The ability to record in a video stream the circumstances that occur while the door is in the closing action. This information provides the ability to minimize false claims of injury as well as record the action of the door to provide detail of door malfunctions.

Eliminate the cables that are currently in use, which can reduce the points of failure in a door protection device as well as decrease maintenance costs.

The invention provides computer vision to monitor the door sweep area processing images at least 20 frames a second. An intelligent decision is made at every frame interval as to whether the door should open or continue closing.

The elevator door control device comprises the following items:

a custom built computing device, which is engaged to analyze the data in real-time.

software which analyzes the data in real-time and makes the intelligent decisions.

a video or digital camera.

special non-visible lighting and lens filters which are used to maintain a non-obtrusive clear scene for the device.

The elevator door control device is mounted on the elevator and the camera is mounted to provide a clear view of the elevator door sweep area. The door motion is analyzed at every frame and an intelligent decision is made to either continue to close the door or engage the door to reopen.

The present invention relates to an apparatus and method which monitors and controls the door sweep area and the door closing function. It is capable of updating rules and modifying the opening and closing criteria, which will enable the elevator door control device to adjust to different circumstances. It thus provides a security feature, which is supported by a video stream, which is captured every time a door obstruction is detected.

Mounted on the elevator is a computer device with software, which controls the door re-opening circuit. This software uses computer vision to monitor the door sweep area processing images at least 30 frames a second. An intelligent decision is made at every frame interval as to whether the door should open or continue closing. A camera (Digital or Analog) is mounted on the elevator in a way in which it has clear view of the door sweep area. Once an obstruction is detected a signal is sent to re-open the door.

The camera may be of any suitable type (Digital or Analog) as long as it is capable of capturing as least 30 frames per second. These pictures are used in the intelligent decision of the device. The camera images are analyzed to view if an obstruction has occurred. As the door closes, as long as an obstruction has not occurred, the door continues to close. If, however, an obstruction is detected, the door will re-open.

The image steam is preserved anytime a door obstruction has occurred. This feature provides added security in that it can determine who entered the elevator at what time, and thereby reduce an opportunity for a criminal act. It can also provide details of any accident occurring while the door is closing.

There is a learning mode, which created a statistical set of data which, is used to determine if there is an obstruction or not. The device compares the images, which are captured during the sequences from door open to door close and all the points in between. The number of images captured during a door close is a variable based on time and the rate of image capture. If the door close event takes four seconds and the images are captured at 30 frames a second or more, then the elevator door control device will analyze 30 frames times seconds or 120 images per door close cycle.

As a preference, at least 20 frames or images a second is desired. More preferably at least 30 frames or images a second is desired. Most preferably about 30 to about 100 frames or images a second is desired.

Analysis is performed on the data using the learned sets the results of which determines if the door will continue to close or re-open. There are variables that can be set in the software that can control the amount of deviation that will be tolerated. Learned sets represent persistent data that the door closing can write to. The learned sets are statistical data that are calculated from the sequence of images that compares the patterns. There can be infinite learned sets and they can be created based on different set of circumstances.

As described in further detail below, the elevator door control device and method disclosed herein differ from the prior art teachings by:

A machine vision device which controls the door opening circuit closing mechanism, which will allow the elevator door to open and close, based on a set of rules contained within the device. These rules are constantly updated as the device operates. The closing and opening device will be able to adjust to different circumstances.

The ability to record in a video stream the circumstances that occur while the door is in the closing action. This will provide the ability to minimize false claims of injury as well as record the action of the door to provide detail of door malfunctions, as well as the ability to be connected to a network, to provide a powerful means of communication, to be connected through the global computer communications network for maintenance, training and safety features. The Video stream from the device can be accessed from any. An image analyzer which is preprogrammed to process images with learned sets and provide meaningful results, either obstruction present in the doorway, or the doorway is clear.

Adjacent to an elevator door is a door control device, which can analyze the opening created by the elevator door. The door control device includes a camera mounted adjacent to the elevator door and an analyzing mechanism capable of analyzing the pictures taken by the camera, and using that analysis to activate the door mechanism, in order to control the opening and the closing of the elevator door.

The camera may be of any suitable type capable of taking a series of analyzable pictures. The camera may be a digital camera, a video camera, an analog camera, or other camera capable of taking a series of analyzable pictures. The preferred camera is a digital camera or an analog camera.

Whatever camera is used must monitor the elevator entrance and take a rapid series of pictures of that entrance for the elevator. Such pictures are analyzed in order to determine, whether the elevator door may be safely operated, especially to either open or close.

The analyzing mechanism must constantly view the pictures or video to determine whether any change has taken place in the area covered by the camera. Once the area covered by the camera remains constant for a desired period of time or a desired series of pictures, the door can then close.

The camera can also save or preserve pictures of he elevator interest area, for future use. This feature provides added security, in that it can determine who entered the elevator at what time, and thereby reduce an opportunity for a criminal to act. It can also provide details of any accident occurring at the closing of the door and make a very accurate determination of any possible injury claims, due to a person being struck by the door, during a closing or an opening procedure.

Any camera, used in the device of this invention, records a series of images. The series of images can be digital images or video images. If it is a still camera, up to fifty frames a second may be used. As these images are read, the information is conveyed to the door closing assembly. The elevator door status and closing assembly can determine when the door should close.

Basically, if the picture frames remain unchanged for a period of time, the door can then be instructed to close. The data derived from the series of pictures provides a learning set, which permits a determination of when the door may close. The low voltage readout from the images caused anything the doorway, together with the computer combination, determines how the door will open and close, and when the door will open or close. If there is any indication of an obstruction, which obstruction can be as little as a finger in the doorway, a voltage readout increases and door will not close, or stop the closing process.

The learning set or learned set can be statistical data calculated from a sequence of digital images using the model to develop and extract delta patterns or exact patterns specific to the application. Such a structure can be applied to each floor on which the elevator opens. There is a power on device which provides the device initialization and diagnostics required for normal operation. The calibration mechanism provides adjustment of the device as desired. The adjustment of the device can be applied in a floor by floor basis.

If such an adjustment is not needed, there is a default or normal operation system that can be used. There is a learning mode within the device using door status voltage readouts and real time images, a sequence of images is obtained from the elevator door from door open to door close.

The imaging processes, techniques and statistical models determine the minimum data required to represent these states or door condition with minimal areas. This data becomes the learned set and upon substantiation of the learned set the power cycle occurs. In this fashion, the door is opened or closed.

The device can be operated in any suitable fashion in the live mode or automatic mode. The door status is determined. If the door opens signal is present, it is continued until the door open signal determines that a certain period of time has passed. If the certain period of time has passed, the door can then close.

The matching of the door opening with the learning set can determine whether the device can be achieved. With the elevator door closing the current door pattern is determined using the time and the last pattern match to obtain a viable range. By matching the pattern, it can be determined whether the door might close or open. The door will not close or the closing procedure will stop, if there is the slightest deviation in the pictures showing a closing path for the door. Thus, by avoiding the cable, and taking the analyzable pictures over the desired time frame, great efficiency is achieved in the operation of the door.

For the purposes of the door control device, the following definitions apply:

Real Time Image—Represents a stream of digital images occurring in real time, preferably at a rate of 25 frames a second or more. Processes can read this image steam.

TTL (transistor-transistor logic)—Elevator door status and control signals are represented by this symbol. Processes can get immediate updates as to door status, whether opened or closed, and can initiate a door operation, either opening or closing.

Learn Set represents persistent data that closing or opening processes can read from or write to. The Learn Set is a statistical set of data calculated from a sequence of digital images using a model that can be developed to extract delta patterns specific to this application.

The camera structure is designed to control the opening and closing of an elevator door. The camera may be a still camera, which can take repeated pictures in a fast sequence such as thirty or more pictures a second. The camera may also be a video camera. Either camera will monitor the elevator interest and constantly view the pictures or video to determine a change in the area. Once the area remains constant for a desired period of time, the door can then close.

The camera can also save pictures for the elevator interest area. This provides added security in that it can determine who entered the elevator at what time. It can also provide details of any accident occurring at the closing of the door and make a very accurate determination of any possible claims due to being struck by the door.

The camera records a series of images. They can be digital images or video images. If it is a still camera, up to thirty or more frames a second may be used. As these images are read, the information is conveyed to the door closing assembly. The elevator door status and closing assembly can then determine when the door should close. Basically, if the pictures, within a time frame, remain unchanged for that period of time, the door can then be instructed or permitted to close.

The data provides a learning set which permits a determination of when the door may open or close. The learning set or learned set can be statistical data calculated from a sequence of digital images, using the model to develop and extract delta patterns or exact patterns specific to the application. Such a structure can be applied to each floor on which the elevator opens.

There is a leaning mode within the device using door status voltage readouts and real time images, a sequence of computer combination determines how the door will open and close. Such images are obtained from the elevator door from door open to door close. The imaging processes, techniques and statistical models determine the minimum data required to represent these states with minimal areas.

As will be described in further detail hereinbelow, the elevator door control device and method disclosed herein differ from the prior art teachings by provision of secondary security enhancement and by creating the elevator door control device to be capable of learning, over time, parameters of the particular installation.

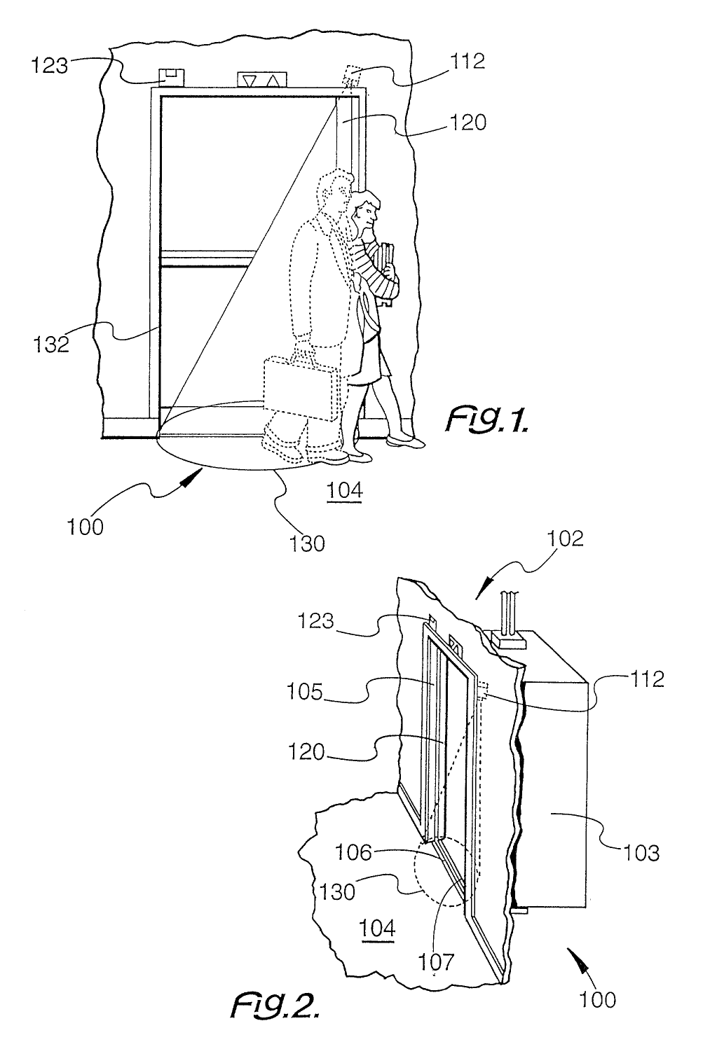

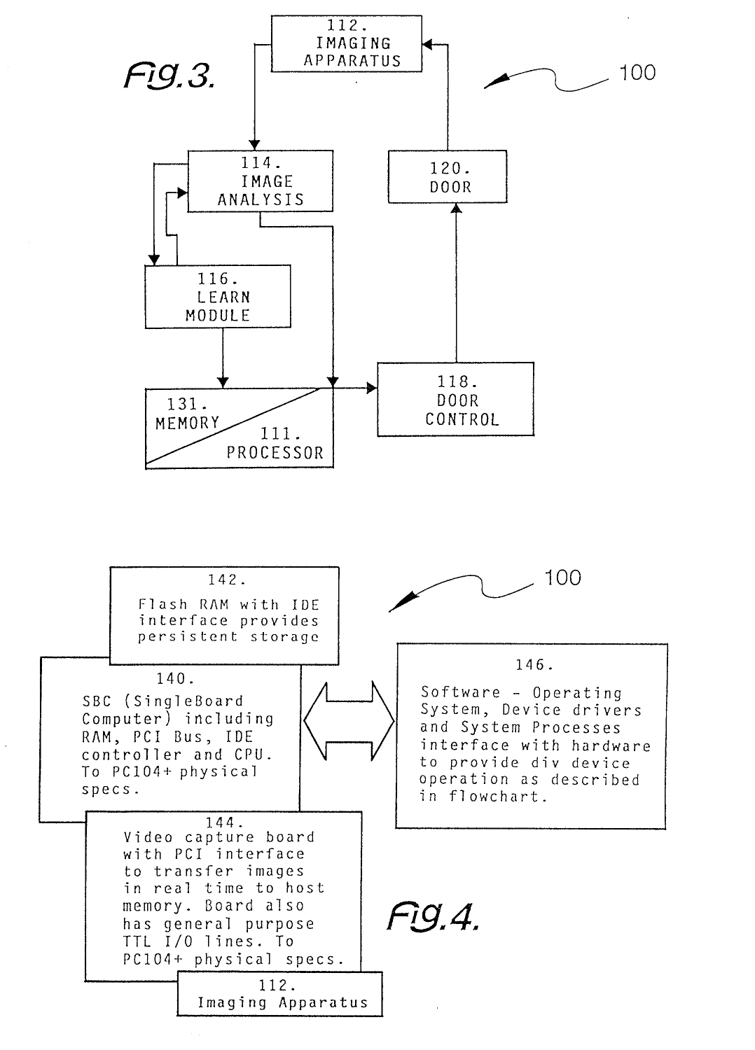

Referring now to the drawings in greater detail and FIG. 1 and FIG. 2 in particular, there is illustrated therein a elevator door control device for controlling operation of a door of an elevator cab made in accordance with the teachings of the present invention and generally identified by the reference numeral 100. There is also disclosed herein the logic steps of the methodology for the elevator door control device 100. While many variations thereof are possible, the scope covers desirable versions of elevator door control device 100.

Elevator 102 includes a passenger cab 103 with a cab door 120 as a closing member therefor. As elevator 102 stops at a floor 104, both cab door 120 and lobby elevator door 105 open to provide for elevator ingress and egress. Lobby sill 106 is at the base of lobby elevator door 105. Cab sill 107 is at the base of cab door 120.

At each floor 104 where the cab 103 of elevator 102 stops, the cab door 120 and the lobby elevator door 105 open together. The lobby elevator door 105 at the floor 104 provides the second elevator door for elevator 102. Both doors 105 and 120 must cooperate for the elevator 102 to function.

FIG. 1 and FIG. 2 provides a graphic representation of elevator door control device 100 in operation. Here, it will be seen that the imaging apparatus 112 is positioned relative to the cab door 120 in a manner to provide images of the area 130 adjacent to a door frame 132 created when the door 120 is open such that obstruction determined to exist within the area 130 will elicit a particular operational response of the elevator door 120. Detection area 130 is the area sills 106 and 107 and the door frame 132 of the doors 105 and 120.

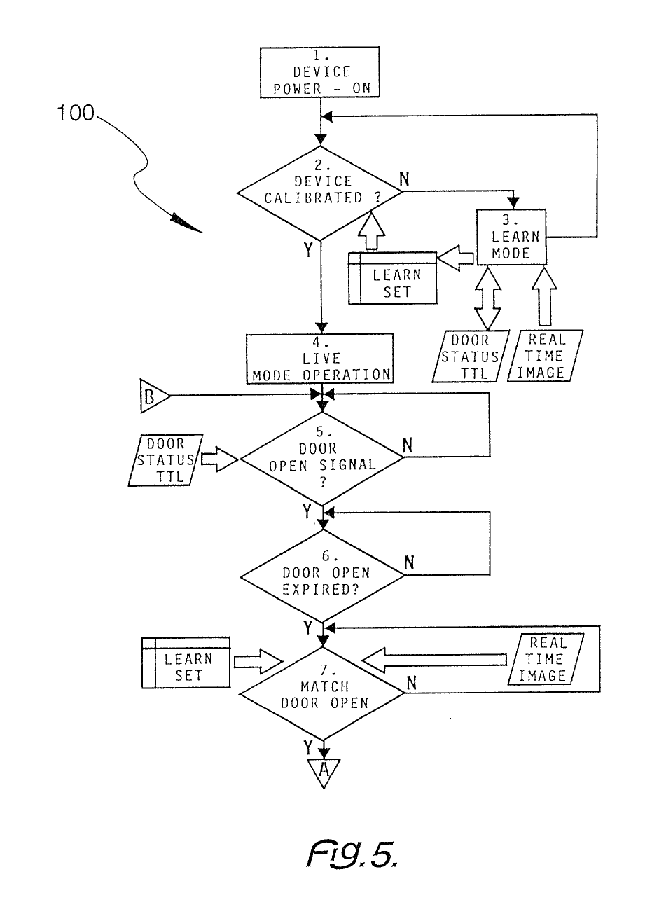

Adding FIG. 3 to the consideration, the elevator door control device 100 includes a preprogrammed processor 111; an imaging apparatus 112 capable of taking at least 20 images a second, such as an analog camera or digital camera; an image analyzer 114, which is preprogrammed to compare sequential images and determine if a change has taken place therebetween; a learning module 116, which is programmed to learn parameters of the particular installation over time; and an elevator cab door control module 118, which is functionally engaged to a cab door 120 of an elevator cab 103 of FIG. 2 for causing controlled operation, and hence positioning, thereof, as well as being functionally engaged to the processor 111 and receiving input therefrom for producing instantaneous actively controlled positioning of the door 120.

All components of the elevator door control device 100, except the imaging apparatus 112, are proposed, in a preferred embodiment, to be contained in a sealed heat sunk enclosure 123, of FIG. 1 and FIG. 2, designed to transfer thermal energy from critical components to the ambient environment.

As stated, the elevator door control device 100 and resulting method are designed to control the operation of an elevator door 120. Simplistically, the imaging apparatus 112 provides images of an area 130 of FIG. 1 and FIG. 2 adjacent to the elevator door 120 continuously, image output from the imaging apparatus 112 being continuously fed to the image analyzer 114 for analysis to determine if any change exists between sequential images of the area 130. When sequential images of the area 130 remain constant over a predetermined time period closure of the door 120 is elicited.

The elevator door control device 100 also saves images of the area 130 over a predetermined time period for review, providing enhanced security. The saved images are viewable through known modalities or may even be obtainable for review in any suitable fashion. Even the computer communication network may be used in the review. One such type of network is known under the trademark INTERNET.

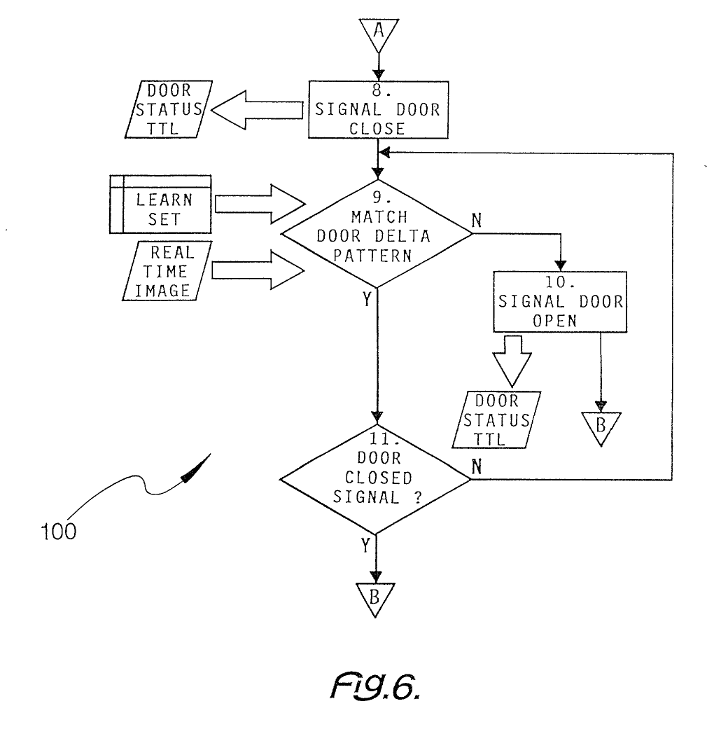

In FIG. 4, a preferred embodiment of the elevator door control device 100 is defined in detail. The processor 111 comprises a single board computer 140 having a flash ram 142 for storage of images and a video capture board 144 functionally engaged to the imaging apparatus 112.

Also, connecting mechanisms 146, which are standard in the computer arts, are provided to assure cooperation between the physical elevator door control device 100 and the methodology logic thereof. Device drivers, interfaces, and similar devices are grouped together as connecting mechanisms 146 for that purpose.

It will be understood that any changes determined to exist within sequential images of the area 130 through comparison of such images provided by the image analyzer 114 must necessarily elicit a particular predetermined reaction of the door 120, most particularly during closing, when a change indicating obstruction in the area 130 is identified.

It will be understood that the elevator door control device 100 and method are proposed for use in maintaining the door 120 open while a constant or a temporary obstruction in the area 130 is detected, eliciting closure of the door 120 only when obstruction in the area 130 is determined to be absent during a predefined time period, and for causing closure of the door 120 to stop and reverse to opening if obstruction is thereafter detected in the area 130 once closure of the door 120 has begun. Obviously, obstruction in the area 130 is determined by the elevator door control device 100 to exist by analysis of sequential images provided by the imaging apparatus 112, and determining if changes exist from one image to the next.

The logic flow diagram of FIG. 5 and FIG. 6 sets forth a preferred embodiment of steps of elevator door control device 100 logic, as are defined in greater detail below. For purposes of clarity, some of the terms used therein are first defined.

Real Time Image in this disclosure represents a stream of digital images occurring in real time at up to 30 frames a second. Processes can read this image stream.

Door Status TTL (transistor-transistor logic) in this disclosure represents elevator door status and control signals. Processes can obtain immediate updates as to door status (Opened or Closed) and can initiate a door operation (Open or Close).

Learn Set in this disclosure represents persistent data that processes can read from or write to; that is, statistical data calculated from a sequence of digital images using a model developed to extract change (delta) patterns specific to this application.

In a preferred embodiment, the logic should minimally include the following steps, though this should not be construed as limiting.

1. System Power-On:

The elevator door control device 100 is energized through use of any suitable power source and initialization and diagnostics required for assuring desire operational functionality of elevator door control device 100 components are performed by the preprogrammed processor 111, shown in FIG. 3.

2. System Calibrated?

Here the processor 111 determines if the elevator door control device 100 needs to be “trained” in the particular installation environment. If so the Learn Mode of Step 3 is initiated. If not, Live Mode Operation of Step 4 is initiated.

3. Learn Mode

The learning module 116, shown in FIG. 3, of the processor 111 creates a Learn Set which is determined, over time, to be required for normal operation of the elevator door control device 100 in the particular installation environment. Using Door Status TTL and Real Time Images the processor 111 is able to obtain input sequences of analyzed images from the analyzer 114, shown in FIG. 3, of the elevator door status from Door Fully Open to Door Fully Closed. Image processing techniques and statistical models are used by the learning module 116, shown in FIG. 3, to determine the minimum data input required to represent door 120, shown in FIG. 3, position status with minimal error. This data input is incorporated into a memory 131 of the processor 111 via the Learn Set created by the module 116. Upon confirmation of successful instantaneous updating of the Learn Set the elevator door control device 100 is then readied for operation in Live Mode.

4. Live Mode Operation

Here, all apparatus of the elevator door control device 100 are recalibrated for operation in Live Mode.

5. Door Open Signal?

Here elevator door 120 status is monitored and input from Door Status TTL is processed. If a Door Open signal is detected, the process continues to step 6. If no signal is present, the process loops as shown.

6. Door Open Expired?

Here time, which passes after the Door Open signal is detected, is monitored. If the time passed is greater than a predefined value programmed into the processor 111, the process continues to step 7. If the time passed is less than or equal to the predefined value, the process loops as shown.

7. Match Door Open?

The processor 111 here attempts to match the expected updated Door Open Pattern from <Learn Set> to the <Real Time Image> input using both image processing and a statistical model. If a match exists the process continues to step 8. If there is no match, the process loops as shown.

8. Signal Door Close

A Door Close signal in, Door Status TTL, elicits door closure, with such action being confined to take place.

9. Match Door Image Chance (Delta) Pattern?

As the elevator door closes, an image change pattern range is determined by attempting to match a pattern range from the, Learn Set, with, Real Time Image, pattern using image processing and a statistical model (using time of Door Close signal assertion and last pattern match to estimate a viable range). If a match exists, the process continues to step 111. If no match is found, the process continues to Step 10.

10. Signal Door Open

When no match is found, a Door Open signal in, Door Status TTL, elicits reversal and opening of the door, with such action being confirmed to take place. At this point, the process loops back to Step 5.

11. Door Closed Signal?

If a match was determined to exist at step 9, a determination of elevator door signal status from <Door Status TTL> is made. If a Door Closed signal is found, the process loops back to step 5. If no door-closed signal exists, the process loops back to step 9.

It will be understood that the method and logic steps thereof defined hereinabove are cyclic, and continuous. Thus, the secondary feature of enhanced security through availability of reviewable images is accommodated.

Further, through provision of the learning capability, a smart version of elevator door control device 100 is assured, wherein all parameters of the particular installation are constantly being upgraded to accommodate for the particular parameters peculiar to the specific installation.

As described above, the elevator door control device 100 and method of the present invention provide a number of advantages, some of which are described above and others of which are inherent in the invention. Also, modifications may be proposed to the elevator door control device 100 and method without departing from the teachings herein.

As such, this application; taken as a whole with the abstract, specification, claims, and drawings being combined; provides sufficient information for a person having ordinary skill in the art to practice the invention as disclosed and claimed herein. Any measures necessary to practice this invention are well within the skill of a person having ordinary skill in this art after that person has made a careful study of this disclosure.

Because of this disclosure and solely because of this disclosure, modification of this method and device can become clear to a person having ordinary skill in this particular art. Such modifications are clearly covered by this disclosure. Accordingly, the scope of the invention is only to be limited as necessitated by the accompanying claims.

What is claimed and sought to be protected by Letters Patent is:

1. An elevator door control device for controlling operation of an elevator door, the elevator door control device comprising:
an imaging apparatus mounted relative to an elevator door in a position for imaging areas adjacent the door;
a preprogrammed module functionally engaged to the imaging apparatus and receiving and analyzing continuous input therefrom, the module also being functionally engaged to operating structures of the door for eliciting opening and closing of the door based on determination of differences between sequential images.

2. An elevator door control device for controlling operation of an elevator door, the elevator door control device comprising:
an imaging apparatus mounted relative to an elevator door in a position for monitoring areas adjacent the door;
a preprogrammed module functionally engaged to the imaging apparatus and receiving input therefrom, the module also being functionally engaged to operating structures of the door for eliciting operation of the door based on analysis of input from the imaging apparatus, the elevator door control device also storing images in a retrievable form.

3. The elevator door control device of claim 1 wherein a determination of no differences between sequential images over a predetermined time period elicits closure of the door.

4. The elevator door control device of claim 1 wherein sequential determinations of differences between sequential images after opening of the door, causes the door to be maintained open.

5. The elevator door control device of claim 3 wherein a determination of differences existing between sequential images after door closure is elicited cause reversal of the door to an open position.

6. The elevator door control device of claim 2 wherein images from the imaging apparatus are stored in a memory of the elevator door control device and can be retrieved as necessary.

7. The elevator door control device of claim 6 wherein the camera is a still digital camera.

8. The elevator door control device of claim 6 wherein the camera is a video camera.

9. The elevator door control device of claim 6 wherein the images from the camera may be stored on a replaceable storage medium.

10. A method for controlling operation of an elevator door comprising the steps of:
providing an imaging apparatus in a position to allow continuous sequential imaging of an area adjacent the elevator door;
providing a preprogrammed image analyzer to the imaging apparatus for analyzing differences between sequential images received from the imaging device;
providing a preprogrammed processor functionally engaged to the image analyzer for determining appropriate door obstruction required by any analyzed differences;
functionally engaging the preprogrammed processor to operating structures of the door;
and, based upon analyzed differences eliciting appropriate obstruction of the elevator door in response to such analyzed differences.

11. An elevator door control device for controlling operation of an elevator door, the elevator door control device comprising:
an imaging apparatus mounted relative to an elevator door in a position for imaging areas adjacent the door;
a preprogrammed module functionally engaged to the imaging apparatus and receiving and analyzing continuous input therefrom, the module also being functionally engaged to operating structures of the door for eliciting opening and closing of the door based on determination of differences between sequential images, the preprogrammed module being provided with a learn set for updating parameters for the particular installation of the elevator door control device.
